(19) United States
(12) Patent Application Publication
(10) Pub. No.: US 2018/0148977 A1
(43) Pub. Date: May 31, 2018

(54) FOLDING LADDER WITH ARMREST

(71) Applicant: NEW-TEC INTEGRATION (XIAMEN) CO., LTD., Xiamen (CN)

(72) Inventor: Luhao LENG, Xiamen (CN)

(73) Assignee: NEW-TEC INTEGRATION (XIAMEN) CO., LTD., Xiamen (CN)

(21) Appl. No.: 15/786,120

(22) Filed: Oct. 17, 2017

(30) Foreign Application Priority Data
Nov. 28, 2016 (CN) 201621283174.4

(51) Int. Cl. E06C 1/393; E06C 1/22; E06C 7/18; A47C 12/00

(52) U.S. Cl. CPC E06C 1/393; E06C 1/22; E06C 1/383; A47C 12/00; E06C 7/182

(57) ABSTRACT

A folding ladder with an armrest, has two front legs, two rear legs, two shaft sleeves and at least a footboard, two shaft sleeves are respectively sleeved on the top portion of the two front legs, the top portion of the two rear legs are respectively rotatably pivoted to the two shaft sleeves; further comprising an armrest, the armrest comprises two movable bars and a link bar, two movable bars are respectively connected to the two front legs in stretchable way, the link bar is connected between the two movable bars; the shaft sleeve is disposed with an adjustable switch to control the movable bar to stretch out and draw back. The adjustable switch has a handle, a position pin disposed at one end of the handle and an elastic element disposed at the other end of the handle.

### TECHNICAL FIELD

The present invention relates to a folding ladder with an armrest.

### BACKGROUND OF THE INVENTION

Ladders are used to help people to fetch things in high position. Ladders comprise straight ladders, unilateral herringbone ladders, bilateral herringbone ladders and other different structure. Therein, as the herringbone ladder can be unfolded to stand stably on the ground when needed and be folded for storage when unneeded, this kind of ladder is the prior choice of the consumer with its convenient usage. However, existing herringbone ladder still has problem that when a person climbs to the top portion of the ladder, his hands have no place to hold, if there is no other fixing thing to hold around the ladder, the person standing on the top portion of the ladder feels unstable, he is easy to fall down, security risk exists.

### SUMMARY OF THE INVENTION

The present invention is provided with a folding ladder with an armrest, which overcomes the disadvantages of the existing known technology. The technical proposal of the present invention is that:

A folding ladder with an armrest, comprising two front legs, two rear legs, two shaft sleeves and at least a footboard, two shaft sleeves are respectively sleeved on the top portion of the two front legs, the top portion of the two rear legs are respectively rotatably pivoted to the two shaft sleeves, the front leg and the rear leg form a foldable herringbone structure through the shaft sleeve, the front portion of one side of the footboard is pivoted to the front leg; wherein further comprising an armrest, the armrest comprises two movable bars and a link bar, two movable bars are respectively connected to the two front legs in stretchable way, the link bar is connected between the two movable bars; the shaft sleeve is disposed with an adjustable switch to control the movable bar to stretch out and draw back, the adjustable switch comprises a handle, a position pin disposed at one end of the handle and an elastic element disposed at the other end of the handle, the central portion of the handle is rotatably pivoted to the shaft sleeve, the front leg is disposed with a through hole corresponding to the position pin, the movable bar is disposed with a plurality of position holes corresponding to the position pin along the length direction; in normal state, the elastic element applies an elastic force on the handle to make the position pin inserted in the position hole through the through hole, the position pin draws out of the position hole by overcoming the elastic force and pressing down the handle to stretch the movable bar out or draw the movable bar back.

Compared to the existing known technology, the technical proposal of the present invention has advantages as follows:

The top portion of the ladder is disposed with an armrest, making it with armrest function. When the user climbs to the higher position, two hands can hold the armrest to provide balance, making the ladder with use security. The armrest is movably connected to the front leg, the movable bar is stretchable with respect to the front leg, the height of the armrest can be fast adjusted according to the height of the user, the present invention has strong function and is suitable to different persons with different height.

### BRIEF DESCRIPTION OF THE DRAWINGS

The present invention will be further described in accordance with the drawings and the embodiments.

FIG. 1 illustrates a schematic diagram of a folding ladder with an armrest of the present invention.

FIG. 2 illustrates a side diagram of the folding ladder with an armrest of FIG. 1.

FIG. 3 illustrates a sectional diagram of the shaft sleeve portion of the folding ladder of FIG. 1.

FIG. 4 illustrates a schematic diagram of the folding ladder of FIG. 1 with the armrest is dropped down.

### DETAILED DESCRIPTION OF THE EMBODIMENTS

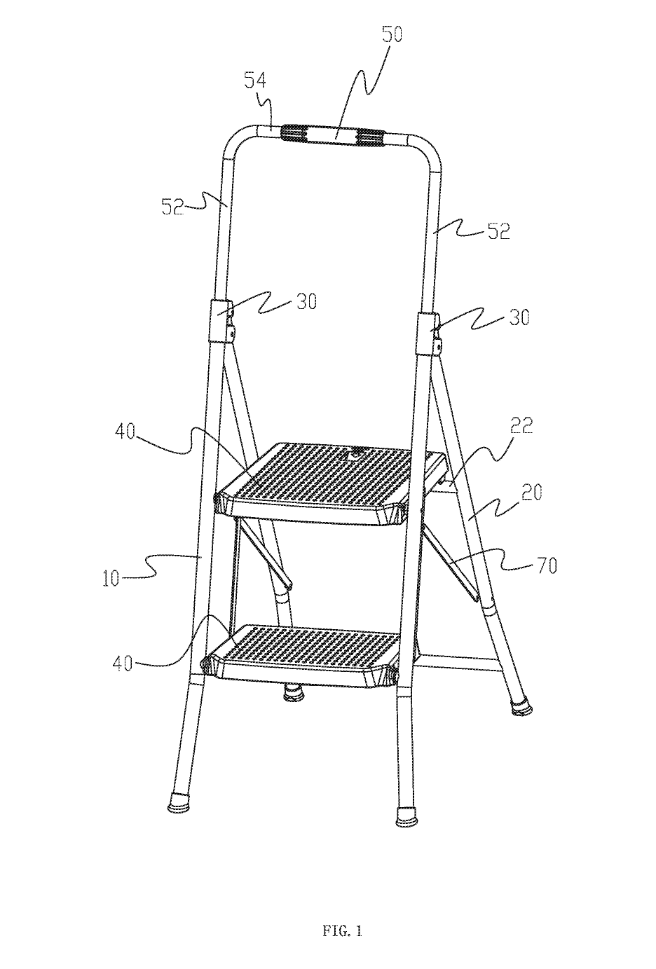

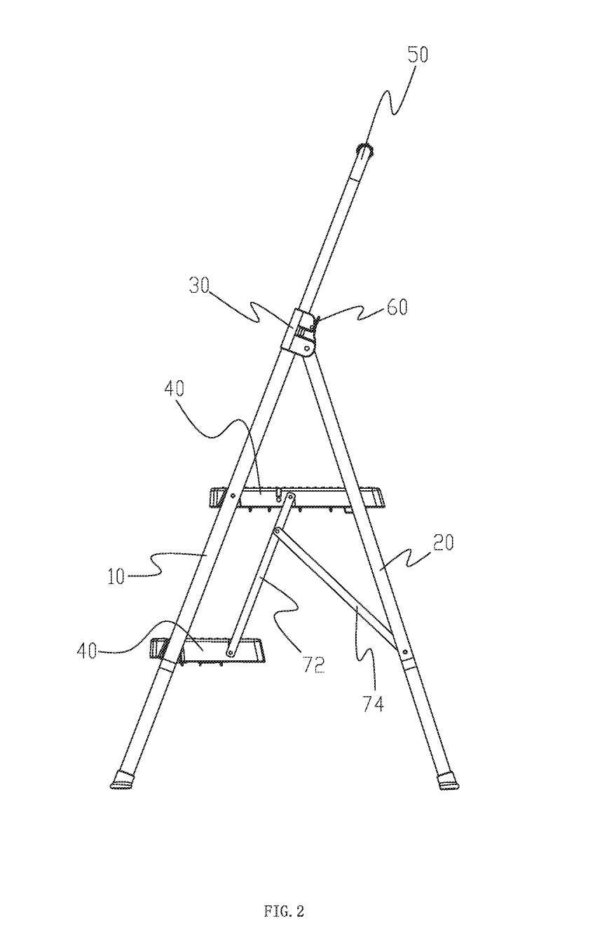

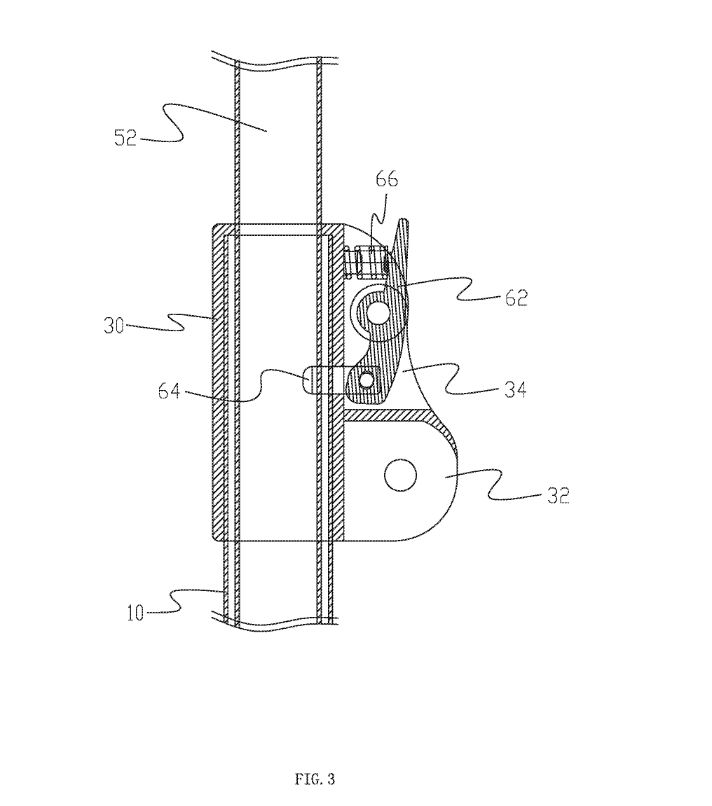

Please referring to FIGS. 1-3, A folding ladder with an armrest comprises two front legs 10, two rear legs 20, two shaft sleeves 30 and at least a footboard 40, two shaft sleeves 30 are respectively sleeved on the top portion of the two front legs 10, the top portion of the two rear legs 20 are respectively rotatably pivoted to the two shaft sleeves 30, the front leg 10 and the rear leg 20 form a foldable herringbone structure through the shaft sleeve 30, the front portion of one side of the footboard 40 is pivoted to the front leg 10. The folding ladder with an armrest further comprises an armrest 50, the armrest comprises two movable bars 52 and a link bar 54, two movable bars 52 are respectively connected to the two front legs 10 in stretchable way, the link bar 54 is connected between the two movable bars 52; the shaft sleeve 30 is disposed with an adjustable switch 60 to control the movable bar 52 to stretch out and draw back, the adjustable switch 60 comprises a handle 62, a position pin 64 disposed at one end of the handle 62 and an elastic element 66 disposed at the other end of the handle 62, the central portion of the handle 62 is rotatably pivoted to the shaft sleeve 30; the front leg 10 is disposed with a through hole corresponding to the position pin, the movable bar 52 is disposed with a plurality of position holes corresponding to the position pin along the length direction; in normal state, the elastic element 66 applies an elastic force on the handle 62 to make the position pin 64 inserted in the position hole through the through hole, making the movable bar 52 and the front leg fixed. The position pin 64 draws out of the position hole by overcoming the elastic force and pressing down the handle 62 to stretch the movable bar 52 out or draw the movable bar 52 back, the movable 52 is then axially stretching out and the strengching length is adjustable.

The armrest 50 is U shaped with an integral structure, H shape is available, or assemble structure is available as well.

The front leg 10 is a hollow tube, the movable bar 52 is inserted in the front leg 10. The rear side of the shaft sleeve 30 is disposed with a pair of fixing pieces 32, the top portion of the rear leg 20 is disposed between the two fixing pieces 32 and is pivoted to the fixing pieces 32. The rear side of the shaft sleeve 30 is disposed with a pair of pivoting pieces 34, the handle 62 is disposed between the two pivoting pieces 34 and is pivoted to the pivoting pieces 34. The pivoting pieces 34 are disposed above the fixing pieces 32.

Preferred, this embodiment compriss two footboards 40 disposed with space upper and lower, a connecting bar 22 is disposed with the two rear legs 20, the connecting bar 22 supports the rear side of the bottom portion of the upper step 40 when the ladder is unfolded; it further comprises two symmetrical connecting mechanisms 70, the connecting mechanisms 70 are used to support the rear portion of the lower footboard 40. The connecting mechanism 70 comprises a pull bar 72 and a swing bar 74, two ends of the pull bar 72 are respectively rotatably pivoted to the rear portion of one side of the lower footboard 40 and the central portion of one side of the upper footboard 40, two ends of the swing bar 74 are respectively rotatably pivoted to the middle-upper portion of the pull bar 72 and the lower portion of the rear leg 20. In fact, the connecting mechanism 70 is the foldable herringbone structure. In addition, the connecting mechanism 70 can be a cross bar disposed between the two rear legs, the cross bar supports the rear portion of the lower footboard 40 when the ladder is unfolded.

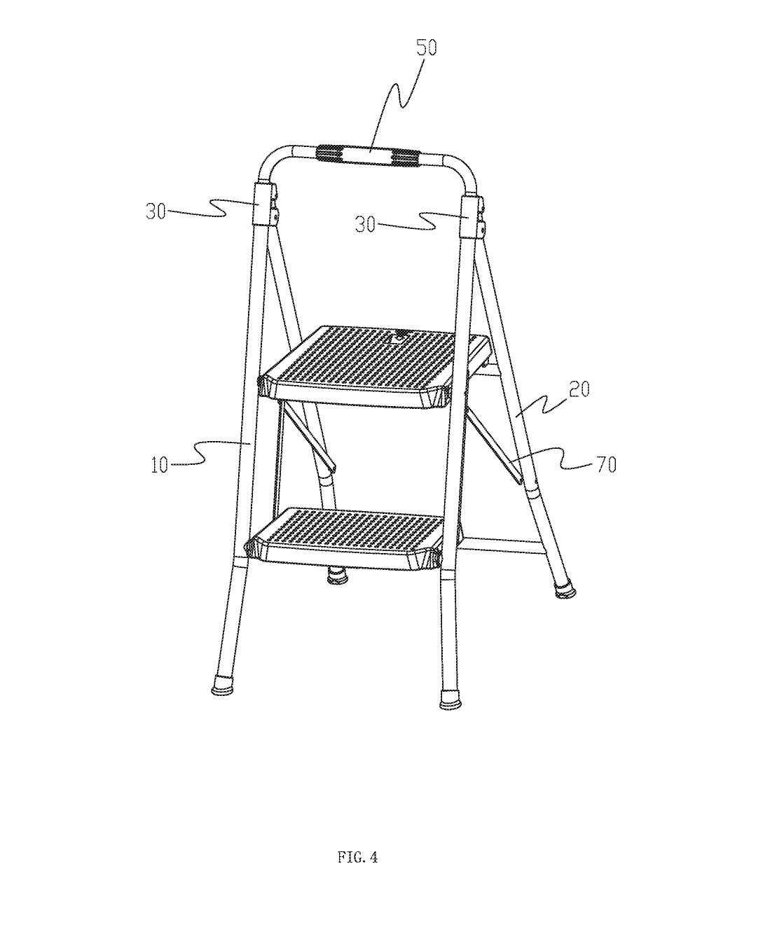

Referring to FIG. 4, the movable bar 52 can stretch out and draw back by pressing the handle 62 down, the height of the armrest 50 is thus adjustable.

Although the present invention has been described with reference to the preferred embodiments thereof for carrying out the patent for invention, it is apparent to those skilled in the art that a variety of modifications and changes may be made without departing from the scope of the patent for invention which is intended to be defined by the appended claims.

1. A folding ladder with an armrest, comprising two front legs, two rear legs, two shaft sleeves and at least a footboard, two shaft sleeves are respectively sleeved on the top portion of the two front legs, the top portion of the two rear legs are respectively rotatably pivoted to the two shaft sleeves, the front leg and the rear leg form a foldable herringbone structure through the shaft sleeve, the front portion of one side of the footboard is pivoted to the front leg; wherein further comprising an armrest, the armrest comprises two movable bars and a link bar, two movable bars are respectively connected to the two front legs in stretchable way, the link bar is connected between the two movable bars; the shaft sleeve is disposed with an adjustable switch to control the movable bar to stretch out and draw back, the adjustable switch comprises a handle, a position pin disposed at one end of the handle and an elastic element disposed at the other end of the handle, the central portion of the handle is rotatably pivoted to the shaft sleeve, the front leg is disposed with a through hole corresponding to the position pin, the movable bar is disposed with a plurality of position holes corresponding to the position pin along the length direction; in normal state, the elastic element applies an elastic force on the handle to make the position pin inserted in the position hole through the through hole, the position pin draws out of the position hole by overcoming the elastic force and pressing down the handle to stretch the movable bar out or draw the movable bar back.

2. The folding ladder with an armrest according to claim 1, wherein the front leg is a hollow tube, the movable bar is inserted in the front leg.

3. The folding ladder with an armrest according to claim 2, wherein the rear side of the shaft sleeve is disposed with a pair of fixing pieces, the top portion of the rear leg is disposed between the two fixing pieces and is pivoted to the fixing pieces.

4. The folding ladder with an armrest according to claim 3, wherein the rear side of the shaft sleeve is disposed with a pair of pivoting pieces, the handle is disposed between the two pivoting pieces and is pivoted to the pivoting pieces.

5. The folding ladder with an armrest according to claim 4, wherein the pivoting pieces are disposed above the fixing pieces.

6. The folding ladder with an armrest according to claim 1, wherein comprising two footboards disposed with space upper and lower, a connecting bar is disposed with the two rear legs, the connecting bar supports the rear side of the bottom portion of the upper step when the ladder is unfolded; further comprising two symmetrical connecting mechanisms, the connecting mechanism comprises a pull bar and a swing bar, two ends of the pull bar are respectively rotatably pivoted to the rear portion of one side of the lower footboard and the central portion of one side of the upper footboard, two ends of the swing bar are respectively rotatably pivoted to the middle-upper portion of the pull bar and the lower portion of the rear leg.

7. The folding ladder with an armrest according to claim 1, wherein the armrest is U shaped.
